(19) United States
(12) Patent Application Publication
(10) Pub. No.: US 2007/0144333 A1
(43) Pub. Date: Jun. 28, 2007

(54) MUSICAL INSTRUMENT CAPABLE OF RECORDING PERFORMANCE AND CONTROLLER AUTOMATICALLY ASSIGNING FILE NAMES

(75) Inventors: Taro Kawabata, Shizuoka-Ken (JP); Takeyoshi Aihara, Shizuoka-Ken (JP)

Correspondence Address: HARNESS, DICKEY & PIERCE, P.L.C., P.O. BOX 828, BLOOMFIELD HILLS, MI, 48303, US

(73) Assignee: Yamaha Corporation, Hamamatsu-shi (JP)

(21) Appl. No.: 11/562,667

(22) Filed: Nov. 22, 2006

(30) Foreign Application Priority Data
Dec. 26, 2005 (JP) 2005-371894

(51) Int. Cl. G10H 7/00; A63H 5/00; G04B 13/00

(52) U.S. Cl. 84/609

(57) ABSTRACT

An automatic player piano has a recorder for recording a performance into a music data file: when a set of music data codes expressing the performance is prepared, a file name is automatically assigned to the music data file through a subroutine program; while the subroutine program is running, the maximum integer, which forms a part of a file name already stored in a memory unit, is determined, and the integer next to the maximum integer is introduced into the file name in so far as the maximum integer is less than the limit of a numerical range, whereby the automatic player piano makes the order of creating the music data files clearly readable from the tile names: when the maximum integer is equal to the limit, a skipped integer is introduced into the file name, whereby the integers in the numerical range are economically reused.

### FIELD OF THE INVENTION

This invention relates to a musical instrument capable of managing music data files expressing performances of tunes and, more particularly, to a musical instrument equipped with a controller managing music files labeled with file names.

### DESCRIPTION OF THE RELATED ART

Music fans enjoy performing music tunes on various musical instruments. They take pleasure in performing music tunes. However, there are music fans who are not satisfied with their performances on the musical instruments. They wish to record their performances on the musical instruments. In order to satisfy this sort of music fans, music manufacturers equip the musical instruments with the ability to record performances thereon. An automatic player piano is, by way of example, equipped with a recorder so that a human player can record his or her performance in a suitable information storage medium.

The automatic player piano is a combination between an acoustic piano and an automatic playing system, and solenoid-operated key actuators, which are controlled by a control unit, are provided under the black and white keys as essential parts of the automatic playing system. While a human player is fingering on the black and white keys, the fingers give rise to the key motion and the black and white keys cause the hammers brought into collision with the strings at the end of free rotation. Then, the hammers give rise to vibrations of strings, and piano tones are produced through the vibrations of strings. Thus, the human player enjoys playing the acoustic piano.

When the human player changes the automatic player piano to an automatic playback mode the control unit sequentially processes music data codes, and selectively energizes the solenoid-operated key actuators. The solenoid-operated key actuators give rise to the key motion instead of the fingers of a human player, and the hammers are brought into collision with the strings as if a human player fingers the tune on the black and white keys. In other words, the automatic playing system plays the tune without any fingering of human player, and the human player enjoys the tune reproduced by the automatic playing system. The music data codes may have formats defined in the MIDI (Musical Instrument Digital Interface) protocols.

The automatic player piano is usually equipped with the recorder, and the music data codes are stored in a suitable information storage medium such as a hard disk by means of the recorder. Thus, the performance on the acoustic piano is recorded in the hard disk in the form of a music data file. A standard MIDI file is a typical example of the music data file.

The recording and other operation such as an automatic playing are realized by means of the control unit, which has a data processing capability, and a suitable computer program runs on the data processor of the control unit for given jobs.

When a human player instructs the control unit to memorize the audio data codes expressing the performance on the acoustic piano, the data processor creates a music data file in the hard disk for storing the audio data codes, and labels the music data file with a file name. The human player inputs a series of characters and/or numerals through keys on the manipulating panel of the control unit for the file name, or the control unit automatically gives the file name to the music data file.

When the human player instructs the playback to the control unit, the control unit produces images of characters and/or numerals, i.e., file name on a display panel thereof so that the human player confirms the tune to be reproduced through the file name.

A typical example of the naming method is disclosed in Japan Patent Application laid-open No. Hei 8-286963. When a human player instructs the control unit to assist him in the naming, the computer program starts to run oil the data processor. First, the data processor produces a list of words on the display panel, and prompts the human player to select a word or words from the list. The human player selects a word or words from the list as a file name. Then, the data processor determines the word or words as the file name.

An example of the file name exhibiting method is disclosed in Japan Patent Application laid-open No. 2002-258853. The music data file has been labeled with plural expressions of a file name. For example, the file name is expressed in Japanese and English, and the Japanese file name and English file name are memorized in the music data file. When the human player instructs the control unit to display the file name, he or she can impose conditions of the display on the data processor. The data processor searches the music data file for the expression of file name, and produces the selected expression of file name. The human player is assumed to impose the condition of language such as English on the data processor. The data processor produces the images of alphabets, which expresses the English expression of file name, on the display panel. Characters and/or numerals expressing a file name are hereinafter simply referred to as a “character string”.

A limit is set on file names of the music data files stored in the prior art automatic player pianos. The file name is to be expressed by eight characters/numerals at the maximum, and an extension is added to the character string The limit may relate to the image producing capability of the display panel of the control unit. The maximum length of character string further sets a limit on the file name so that users can not label music data files with long file names. In other words, users have to name the music data files, simply. Even if a human player wishes to accumulate his or her performances of a tune in time sequence, the limit on the character string makes it hard to express the recording date in the file name.

If the manufacturer changed the naming protocol, it would be possible to prolong the character string of the file name. However, the music data files defined in the new protocol are not used in the old models of the automatic player piano. Thus, there is a trade-off between the compatibility of music data files and the amount of information given to users.

### SUMMARY OF THE INVENTION

It is therefore an important object of the present invention to provide a controller, which permits users exactly to manage music data files without loss of compatibility.

It is also an important object of the present invention to provide a musical instrument, which is equipped with the recorder.

In accordance with one aspect of the present invention, there is provided a controller for automatically assigning a file name to a music data file comprising a music data file producer creating a music data file in a memory for storing a set of music data codes, and a file name assigner assigning a file name to the music data file and including a first searcher searching the memory for a maximum number forming a part of another file name assigned to another music data file already stored in the memory, a second searcher searching the memory for a skipped number less than the maximum number and a namer introducing the skipped number into the file name when the second searcher finds the skipped number and assigning the file name to the music data file.

In accordance with another aspect of the present invention, there is provided a musical instrument for performing a piece of music comprising plural manipulators selectively manipulated by a human player for specifying pitch names along the piece of music, a tone generating system connected to the plural manipulators and producing tones having the pitch names, a music data producer connected to the plural manipulators and producing a set of music data codes expressing a performance along the piece of music, a music data file producer creating a music data file in a memory for storing the set of music data codes, and a file name assigner assigning a file name to the music data file and including a first searcher searching the memory for a maximum number forming a part of another file name assigned to another music data file already stored in the memory, a second searcher searching the memory for a skipped number less than the maximum number and a namer introducing the skipped number into the file name when the second searcher finds the skipped number and assigning the file name to the music data file.

In accordance with yet another aspect of the present invention, there is provided a controller for automatically assigning a file name to a music data file comprising a music data file producer creating a music data file in a memory for storing a set of music data codes, and a file name assigner assigning a file name to the music data file and including a first searcher searching the memory for another music data file having a maximum number less than a limit of numerical range and a namer introducing the number next to the maximum number into the file name and assigning the file name to the music data file.

In accordance with still another aspect of the present invention, there is provided a musical instrument for performing a piece of music comprising plural manipulators selectively manipulated by a human player for specifying pitch names along the piece of music, a tone generating system connected to the plural manipulators and producing tones having the pitch names, a music data producer connected to the plural manipulators and producing a set of music data codes expressing a performance along the piece of music, a music data file producer creating a music data file in a memory for storing the set of music data codes, and a file name assigner assigning a file name to the music data file and including a first searcher searching the memory for another music data file having a maximum number less than a limit of numerical range and a namer introducing the number next to the maximum number into the file name and assigning the file name to the music data file.

### BRIEF DESCRIPTION OF THE DRAWINGS

The features and advantages of the controller and musical instrument will be more clearly understood from the following description taken in conjunction with the accompanying drawings, in which

FIG. 1 is schematic view showing an automatic player piano according to the present invention, and

FIG. 2 is a view showing the constitution of a file name,

FIG. 3 is a flowchart showing a job sequence of a subroutine program for assigning a file name to a music data file,

FIG. 4 is a flowchart showing another job sequence of the subroutine program for assigning a file name to a music data file, and

FIG. 5 is a flowchart showing yet another job sequence of the subroutine program for assigning a file name to a music data file

### DESCRIPTION OF THE PREFERRED EMBODIMENTS

A musical instrument embodying the present invention is prepared for a human player, and the human player performs a piece of music on the musical instrument. The musical instrument largely comprises plural manipulators, a tone generating system, a music data producer and a music data file producer. The plural manipulators are connected to the tone generating system and the music data producer. While the human player is performing the piece of music, the human player selectively moves the manipulators for specifying pitch names of tones to be produced, and the movements of manipulators are reported to the tone generating system and the music data producer. The tone generating system is responsive to the movements of manipulators so as to produce the tones, and the music data producer is also responsive to the movements of manipulators so as to produce a set of music data codes expressing the performance along the piece of music. Upon completion of the performance, the music data file producer creates a music data file in a memory for storing the set of music data codes, and the file name assigner automatically assigns a file name to the music data file. Thus, the performance is recorded in the memory as a music data file, which is specified with the file name.

The file name assigner includes a first searcher, a second searcher and a namer. In this instance, the first searcher, second searcher and namer are implemented by software. File names contain numbers, and the numbers are selected from a predetermined numerical range. The first searcher searches the memory for a maximum number less than a limit of numerical range. The maximum number forms a part of another file name assigned to another music data file, and the music data file has been already stored in the memory. The second searcher searches the memory for a skipped number less than the maximum number. When the second searcher finds the skipped number, the second searcher informs the namer of the skipped number, and the namer introduces the skipped number into the file name, and assigns the file name to the music data file.

Plural music data files are usually accumulated in the memory, and the user sometimes eliminates a music data file from the memory. When the music data file is eliminated from the memory, the file name becomes invalid, and the number, which is incorporated in the invalid file mane, becomes the skipped number. If the skipped numbers were not reused, the number would reach the limit of the numerical range. The file name assigner is effective against the undesirable situation. The file name assigner reuses the skipped numbers so that a large number of music data files are accumulated in the memory. Thus, the file name assigner embodying the present invention economically assigns the numbers to the file names.

Another musical instrument embodying the present invention comprises plural manipulators, a tone generating system, a music data producer, a music data file producer and a file name assigner. The plural manipulators, tone generating system, music data producer and music data file producer are similar to those described hereinbefore. For this reason, description is focused on the file name assigner.

The file name assigner cooperates with the music data producer, and assigns a file name to a music data file. The file name assigner includes a first searcher, a second searcher and a namer. The first searcher searches the memory for another music data file having a maximum number less than a limit of numerical range. When the first searcher finds the maximum number the namer introduces the number next to the maximum number into the file name, and assigns the file name to the music data file.

Since the file name assigner sequentially assigns the numbers to the file names, it is easy for users to find the newest music data file because the numbers are indicative of the order of recording the performances. Thus, the users quickly find the newest music data file with the assistance of the file name assigner embodying the present invention.

### First Embodiment

In the following description term “front” is indicative of a position closer to a human, who gets ready to finger, than a position modified with term “rear”. A line drawn between a front position and a corresponding rear position extends in “a fore-and-aft direction”, and a lateral direction crosses the fore-and-aft direction at right angle.

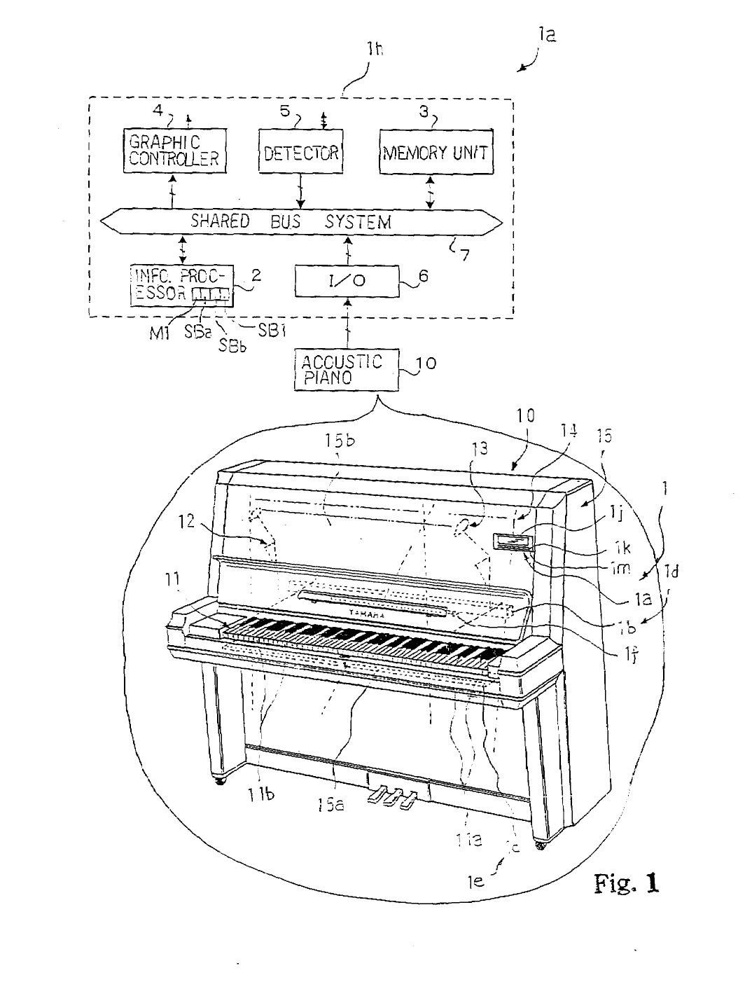

Referring first to FIG. 1of the drawings, an automatic player piano embodying the present invention largely comprises an electric system 1 and an acoustic piano 10. The electric system 1 is installed in the acoustic piano 10. Automatic playing and recording are carried out by means of the electric system 1, and a human player performs a tune on the acoustic piano 10.

The acoustic piano 10 is an upright piano, and includes a keyboard 11, action units 12, hammers 13, strings 14 and a piano cabinet 15. The keyboard 11 has black keys 11a and white keys 11b, which are laid on the well-known pattern, and the black and white keys 11a/11b are independently moved from rest positions to end positions. The keyboard 11 is mounted on a key bed 15a of the piano cabinet 15, and is exposed to a human player who sits in front of the keyboard 1.

The action units 12, hammers 13 and strings 14 are accommodated in the piano cabinet 15. The action units 12 are provided over the rear portions of the black and white keys 11a/11b, and are connected to the rear portions of the associated black and white keys 11a/11b through capstan buttons. While the black and white keys 11a/11b are staying at the rest positions, the hammers 13 are resting on the associated action units 12, and are opposed to the strings 14 stretched in the up-and-down direction.

While the black and white keys 11a/11b are traveling from the rest positions toward the end positions, the capstan buttons upwardly push the action units 12 so as to cause the action units 12 to rotate around whippen flanges (not shown), and the action units 12 escape from the hammers 13 at intermediate points on the trajectories. Then, the hammers 13 start free rotation, and are brought into collision with the strings 14 at the end of free rotation. The strings 14 vibrate, and piano tones are produced through the vibrations of the strings 14.

The electric system 1 includes a controller 1a, an array of solenoid-operated key actuators 1b and an array of key sensors 1c. The controller la and solenoid-operated key actuators 1b as a whole constitute an automatic player 1d, and the controller 1a and array of key sensors 1c form in combination a recorder 1e. The automatic player 1d is responsive to an instruction given by a user, and reenacts a music performance on the acoustic piano 10 without any fingering of a human player. On the other hand, a music performance on the acoustic piano 10 is recorded by the recorder 1c. While a human player is fingering a piece of music on the acoustic piano 10, the recorder 1e analyzes the key motion and pedal motion so as to produce music data codes representative of the musical performance on the acoustic piano 10, and creates a music data file for the music data codes. The music data file is labeled with a file name. In this instance, the music data codes express MIDI messages, and the music data file is created in accordance with the standard MIDI file protocols.

The array of solenoid-operated key actuators 1b is provided on the key bed 15a under the rear portions of the black and white keys 11a/11b, and is connected to a driving circuit If. Each of the solenoid-operated key actuators 1b has a solenoid and a plunger. While the driving circuit 1f is supplying a driving signal to the solenoid, magnetic field is created around the solenoid, and magnetic force is exerted on the plunger in the magnetic field. Then, the plunger upwardly projects, and pushes the rear portion of the associated black key 11a or white key 11b. The controller 1a sequentially informs the driving circuit 1f of the black and white keys 11a/11b to be moved for producing the piano tones and further of the amount of mean current to be supplied to the associated solenoid-operated key actuators 1b. When the time to move a black key 11a or white key 11b comes, the driving signal, which is adjusted to the amount of means current, is supplied from the driving circuit 1f to the solenoid-operated key actuator, and the solenoid-operated key actuator 1b pushes the rear portion of the black/white key 11a/11b with the plunger. Thus, the solenoid-operated key actuators 1b give rise to the key motion without any fingering of a human player so as to vibrate the strings 14.

The array of key sensors 1c is provided under the front portions of the black and white keys 11a/11b, and is mounted on the key bed 15a. Each of the key sensors 1c has a shutter plate, a pair of sensor heads, a light emitting unit and a light detecting unit. The sensor heads of the pair is shared with adjacent key sensors 1c, and the light emitting unit and light detecting unit are shared with the other key sensors 1c. The shutter plate is secured to the lower surface of the front portion of associated one of the black and white keys 11a/11b, and is moved together with the associated black and white key 11a/11b. The sensor heads of the pair are provided on both sides of the trajectory of the shutter plate, respectively, and the gap between the sensor heads is bridged with a light beam. The light emitting unit periodically emits light and the light is distributed to selected ones of the sensor heads for producing the light beams. On the other hand, the light detecting unit converts the incident light to electric current, and produces key position signals representative of current key positions of the black and white keys 11a/11b.

While a black/white key 11a/11b is traveling from the rest position toward the end position, the light beam is gradually interrupted with the shutter plate, and the amount of light is decreased. Thus, the current key position is converted to the amount of incident light on the light detecting unit, and the light detecting unit converts the incident light to the key position signal.

The controller I a includes an information processing unit 1h, a display panel 1j, an array of keys and switches 1k and a casing 1m. The casing 1m is embedded in the piano cabinet 15, and has a front panel exposed on an upper front board 15b of the piano cabinet 15. The display panel 1j and array of keys and switches 1k are provided on the front panel of the casing 1m so as to be opposed to a human player who gets ready for playing. In this instance, the display panel 1j is implemented by a liquid-crystal display panel. However, other sorts of image producing device such as, for example, an array of light emitting diodes and an electro-luminescence panel are available for the controller 1a.

It is desirable for users that the display unit 1j is as narrow as possible in order to prevent the external appearance of the acoustic piano 10 from being poor. For this reason, the number of characters and numerals on the display unit 1j is restricted by the size of display unit 1j and the length of file name handled under the control of the operating system loaded in the controller 1h. In this instance, the display unit 1j is adapted to be as wide as the maximum length of character strings expressing file names.

The information processing unit 1h includes an information processor 2, a memory unit 3, a graphic controller 4, a detector 5, a signal interface 6, which is abbreviated as “I/O”, and a shared bus system 7. The information processor 2, memory unit 3, graphic controller 4, detector 5 and signal interface 7 are connected to the shared bus system 7 so that the information processor 2 is communicable with the memory 3, graphic controller 4, detector 5 and signal interface 6 through the shared bus system 7.

The information processor 2 is an origin of data processing capability of the controller 1h, and a program memory and a working memory are incorporated in the information processor 2 together with an arithmetic and logic unit, a controller and other peripheral circuits. An address location in the random access memory is assigned to a software clock for measuring a lapse of time. The information processor 2 may be implemented by a monolithic microcomputer or a circuit board on which a monolithic microprocessor, read only memory devices, random access memory devices and other peripheral devices are mounted. Otherwise, the information processor 2 is implemented by a logic circuit. The information processor 2 sequentially executes instruction codes, which form a computer program, so as to accomplish jobs.

The memory unit 3 has large data holding capability, and music data files are stored in the memory unit 3. A file directory is prepared for the music data files, and the information processor 2 manages the music data files with the assistance of the file directory. The music data files are respectively labeled with file names, and the file directory makes addresses respectively assigned to the music data files corresponding to the file names. A hard disk unit, a flexible disk unit, a floppy (trademark) disk unit, a compact disk unit such as, for example, a CD-R disk unit, an MO (Magneto-Optical) disk unit and a memory stick are available for the memory unit 3.

The graphic controller 4 is connected to the display panel 1j, and produces visual images on the display panel 1j. The file directory is visualized oil the display panel 1j by means of the graphic controller 4. The graphic controller 4 further visualizes a job menu, prompt messages, acknowledgement and current status of the automatic player piano and so forth on the display panel 1j.

The detector 5 is connected to the array of keys and switches 1k, and periodically checks the keys and switches 1k of the array to see whether or not a user manipulates at least one of the keys and switches 1k. When the detector 5 finds a key or switch 1k already manipulated by the user, the detector specifies the key or switch 1k, and informs the information processor 2 of the manipulated key or switch 1k through the shared bus system 7.

The signal interface 6 includes a data buffer, an analog-to-digital converter and a digital-to-analog converter, and the light emitting unit and light detecting unit of the array of key sensors 1c and the driving circuit 1f are connected to the signal interface 6. While a human player is playing a tune on the acoustic piano 10, the array of key sensors 1c periodically reports the current key positions of all the black and white keys 11a/11b as the key position signals. The signal interface 6 converts the key position signals to digital key position signals through the analog-to-digital converter, and puts the digital key position signals in the data buffer. The information processor 2 fetches the digital key position signals from the data buffer for the data processing hereinlater described in detail.

The computer program is broken down into a main routine M1 and subroutine programs SBa, SBb, SB1, . . . . While the main routine program M1 is running, the information processor 2 checks the detector 5 to see whether or not the user manipulates the keys and switches 1m. The user selects a mode of operation from the job list, and gives his or her option to the information processor 2.

One of the subroutine programs SBa is assigned to the automatic player 1d, and another subroutine program SBb is assigned to the recorder 1e. A file name is given to a music data file through yet another subroutine program SB1, which will be hereinlater described in detail.

When a user selects the automatic playing mode of operation, the main routine program M1 starts periodically to branch to the subroutine program SBa for the automatic player 1e. The user selects a file name from the file directory, and information processor 2 transfers the music data file labeled with the file name from the memory unit 3 thereto. The music data file is stored in the random access memory.

The information processor 2 starts to measure the lapse of time, and searches the music data file to see whether or not any note event. i.e., a note-on event or a note-off event is to occur. While the answer is given negative, the information processor 2 periodically increments the software clock, and waits for the change of answer. When the information processor 2 finds a music data code expressing the note event to occur, the information processor 2 determines a target trajectory, i.e., a series of values of key position for the black/white key 11a/11b on the basis of the music data code, and further determines the amount of mean current for the driving signal. The information processor 2 informs the driving circuit if of the key number assigned to the black and white key 11a/11b to be moved and the amount of means current through the signal interface 6.

The driving circuit 1f adjusts the driving signal to the amount of mean current, and supplies the driving signal to the solenoid-operated key actuator 1b associated with the black/white key 11a/11b. The plunger upwardly projects from the solenoid, and pushes the rear portion of the black and white key 11a/11b. Thus, the solenoid-operated key actuator 1b gives rise to the key motion without any fingering of a human player. A feedback signal, which expresses the plunger velocity, is supplied from a built-in plunger sensor to the information processor 2, and the information processor compares the current plunger velocity and current plunger position with the key velocity and key position on the target trajectory to see whether or not the black/white key 11a/11b travels exactly on the target trajectory.

While the answer is being given affirmative, the information processor 2 keeps the amount of mean current at the present value. If the black/white key 11a/11b advances or is delayed, the answer is given negative, and the information processor 2 decreases or increases the amount of mean current. The information processor 2 informs the driving circuit If of the amount of mean current, and the driving circuit If regulates the driving current to the amount of means current. Thus, the black/white key 11a/11b is controlled through the servo loop so as to cause the hammer 12 to be brought into collision with the string 13 at target hammer velocity.

When the information processor 2 finds a music data code expressing the note-off event, the information processor 2 informs the driving circuit 1f of the key number, and the driving circuit 1f decays the driving signal to the inactive level. The plunger is retracted into the solenoid, and the black/white key 11a/11b returns to the rest position.

The information processor 2 repeats the above-described feedback control sequence for all of the black and white keys so that the black and white keys 11a/11b are sequentially moved by the automatic player 1d. Thus, the automatic player 1d reenacts the performance recorded in the music data file without any fingering of a human player.

A human player is assumed to instruct the recorder 1e to record his or her performance through the array of keys and switches 1m. The main routine program M1 starts periodically to branch to the subroutine program SBb for the recorder 1e. The information processor 2 starts periodically fetch the digital key position signal from the signal interface 6, and accumulates the current key positions of the black and white keys 11a/11b in the random access memory.

The information processor 2 analyzes the pieces of key position data represented by the accumulated digital key position to see whether or not the black and white keys 11a/11b cause the associated hammers 12 to be brought into collision with the associated strings 14 and whether or not the black and white keys 11a/11b cause dampers (not shown) to decay the vibrations of the strings 14. When the answer or answers are given affirmative, the information processor 2 admits the note-on event and/or note-off event, and stores the piece or pieces of music data, which express the note-on event and/or note-off event, together with the lapse of time from the previous note event in the music data code or codes. The above-described jobs are repeated for depressed keys 11a/11b and released keys 11a/11b.

When the human player completes his or her performance, the information processor 2 normalizes the pieces of music data represented by the music data codes, and creates a music data file for the set of music data codes. The information processor 2 eliminates noise due to individualities of the acoustic piano 10 from the pieces of music data. Thus, the music data file is created through the execution of the subroutine program SBb. In this instance, the music data file is created in accordance with the MIDI protocols, and is usually referred to as a standard MIDI file.

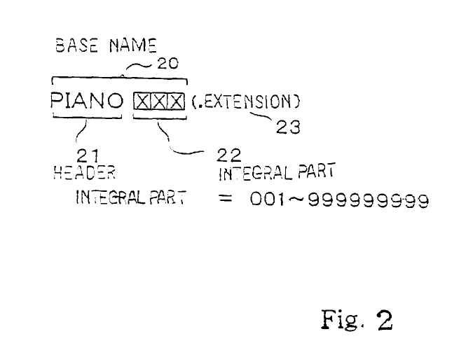

Upon completion of the normalization, the information processor 2 enters into the subroutine program SB1 for a file name. First, description is made on the constitution of the file name with reference to FIG. 2.

FIG. 2 shows an example of the file name. The file name is broken down into a base name 20 and an extension 23, and the base name 20 has a header 21 and an integral part 22. In other words, the header 21, integral part 22 and extension 23 form in combination the file name.

The extension is expressed by a period and a character string, and the base name is the remaining portion of the file name, i.e., the difference between the character string expressing the file name and the extension. In case where a character string “ABCD.xxx” is assigned to a music data file as the File name, the character string “ABCD” is the base name, and “xxx” is the extension. If more than one period is introduced into a character string expressing a file name, the last period and a character string after the last period express the extension. For example, a file name is assumed to be expressed as “ABCD.xxx.wav”. The last period and character string “wav”, i.e., “.wav” expresses the extension.

A character string expresses the header 21, and the character string “PIANO” is corresponding to the header 21 in FIG. 2. The integral part 22 is expressed by a positive integer of 3 figures to 9 figures in the decimal notation, i.e., “1” to “999999999”. When the positive integer is less than 100 in decimal notation, the zero-padding is carried out for the positive integers less than 100. For example, if the positive integer is equal to 1 in decimal notation, the positive integer is expressed as “001”.

When a new music data file is created in the memory unit 3, the positive integer is incremented by 1. For this reason, the integral part 22 informs users of the recording order, i.e., whether a music data file is created before or after the other music data files. The positive integers from “001” to “999” are firstly assigned to music data files, and, thereafter, the positive integers of 4 figures or more are used as the integral part 22. Most of the music data files will have the integral parts expressed by the positive integers equal to or less than 3 figures.

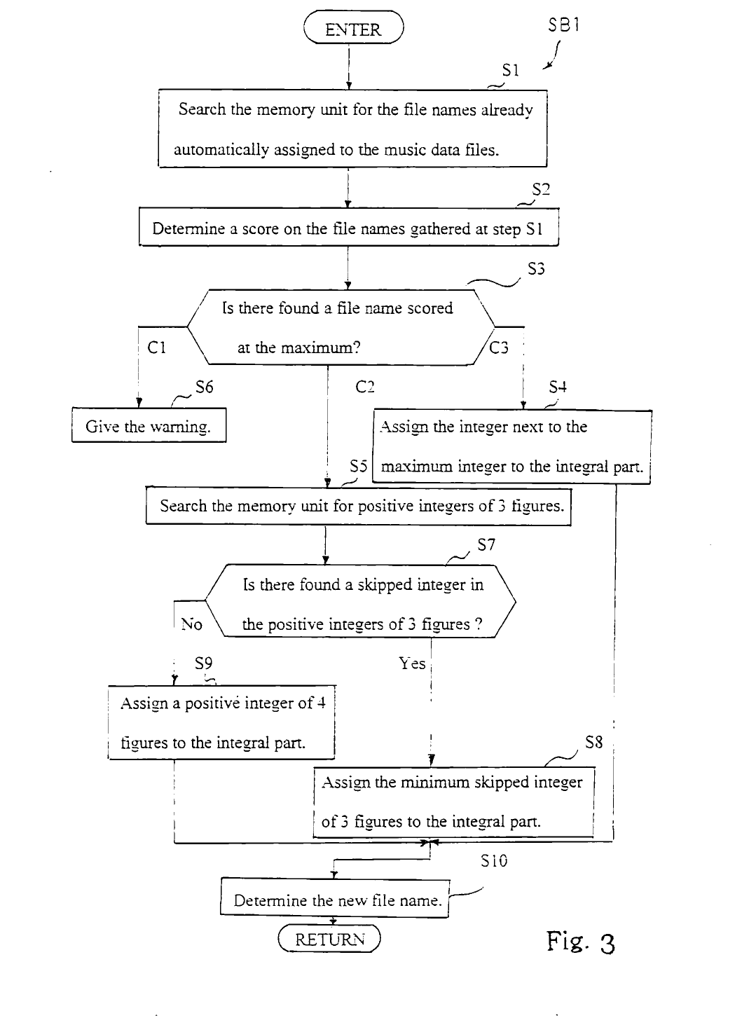

FIG. 3 shows a job sequence of the subroutine program SB1 for assigning a file name to a music data file.

When a human player instructs the information processor 2 to store a set of music data codes expressing his or her performance, the information processor 2 enters the subroutine program SB1 for assigning a new file name. When a user instructs the information processor 2 to duplicate a music data file in and transfer a music data file into the memory unit 3, the information processor 2 also enters the subroutine program SB1 for assigning a new file name. The new file name is assumed to be registered with the file directory.

First, the information processor 2 searches the memory unit 3 for file names, which are analogous to a file name to be newly assigned to the new music data file, as by step S1. The analogous file name names have been already automatically assigned to the music data files through the execution of the subroutine program SB1. The new file name is assumed to be same as the file name shown in FIG. 2. When a music data file satisfies the following conditions, the music data file is considered to be analogous. The conditions are:
1. The header 21 is same as that of the new file name, i.e., the header is expressed by the character string “PIANO”. Even if a header does not consist of the five capital letters, the header is considered to be same as the header “PIANO” 21.
2. The integral part 22 is expressed by a positive integer of 3 figures, i.e., “1”, “2” . . . or “9” occupies each of the three figures. Otherwise, the integral part 22 is expressed by a positive integer of more than 3 figures; and the character at the highest figure is one of “1” to “9”, and “0”, “1”, . . . or “9” occupies the other figures.
3. The integral part 22 ends the file name, i.e., the file ending symbol is found at the end of the character string. Otherwise, an extension 23 follows the integral part 22, and the file ending symbol is found after the extension.
   The file ending symbol is indicative of the end of the character string expressing a file name. However, the file ending symbol is not displayed on the display panel 1j.

File names, which are manually assigned to music data files by users are omitted from a list of analogous file names through the job at step S1. Examples of the file names to be omitted from the list are
1. “SONATA0001” because the header is different from the header “PIANO”,
2. “PIANO01A. mid. wav”, because the integral part contains tile period and alphabet letters.
3. “PIANO0123.mid”, because “0” occupies the highest figure of the integral part, and
4. “PIANO01.mid”, because the integral part is expressed by a positive integer of less than 3 figures.

Subsequently, the information processor 2 determines a score for each of the integral part 22 of the file names in the list as by step S2. Although the integral part 22 is expressed by binary numerals, the positive integer is evaluated as a decimal numeral, and determines the score for each of the file names. By virtue of the evaluation, the arithmetic operation becomes simple. Since the header 21 is expressed by the alphabet letters “PIANO”, the header 21 is eliminated from the file names in the determination of score. As a result, the load on the information processor 2 is reduced.

Description is hereinafter made on the relation between the integral part and the score. A table, which defines the relation between integers and alphabet letters/numerical letters, is prepared in the read only memory of the information processor 2. All the possible character strings are uniquely corresponding to values of score in the table.

The information processor accesses the table with the character string, and reads out a score corresponding to the character string. A character string “PIANO100” may be corresponding to a score point of “a hundred”. The comparison between a value of score and another value of score is advantageous over the comparison between a character string and another character string.

First, the former is much faster than the latter, because any complicated algorism is not required for the comparison between the score points. Second, the information processor 2 can correctly compare the score points with one another. Assuming now the evaluation is carried out by using the comparison function for character strings in the C language on the basis of POSIX, the character string “PIANO 200” has a score point greater than the score point of character string “PIANO 1000”. This is because of the fact that “2” is greater than “1”. On the other hand, the character string “PIANO 200” has a score point less than the score point of character string “PIANO 1000”. Thus, the comparison between the score points is advantageous.

Subsequently, the information processor 2 checks the score to see what fine name has the maximum point as by step S3. The information processor 2 proceeds to one of steps S4, S5 and S6 depending upon the maximum point. If all of the file names do not satisfy the conditions 1, 2 and 3, the maximum score is deemed to be “0”.

There are three possibilities C1, C2 and C3. The possibilities C3, C2 and C1 lead the information processor 2 to steps S4, D5 and S6, respectively, and steps 8 and 9 follow step D5.

If the maximum score is fallen within the range from “0” to “998” or the range from “1000” to “999999998”, the answer at step S3 is given “C3”, and proceeds to step S4. The information processor 2 adds “1” to the maximum point, and assigns the positive integer next to the maximum integer to the integral part 22 by step S4. This feature is desirable, because it is easy to find the newest music data file by comparing the score points with one another. Upon completion of the job at step S4, the information processor 2 proceeds to step S10.

If the maximum score is equal to “999”, the answer at step S3 is given “C2”, and the information processor 2 searches the memory unit 3 for positive integers of 3 figures as by step S5. Subsequently, the information processor 2 checks the integral parts of the file names found at step S5 to see whether or not a skipped integer of 3 figures is found as by step S7. When the information processor 2 finds skipped integers of 3 figures, the information processor 2 assigns the minimum skipped integer of 3 figures to the integral part 22 as by step S8. Thereafter, the information processor 2 proceeds to step S10.

When music data files were eliminated from the memory unit 3, the file names of the eliminated music data files became invalid, and the positive integers in the invalid file names are found to be the skipped integers. Thus, the positive integers of 3 figures are economically used for the file names.

By the way, when the information processor 2 does not find any music data files to be scored, zero is given to the maximum score at step S2. It is apparent not to take the maximum score point of zero into account at step S7.

When the information processor 2 does not find any skipped integer of 3 figures, the answer at step S7 is given negative “No”, and the information processor 2 gives a positive integer of 4 figures to the integral part 22 of the new file name as by step S9, and, thereafter, proceeds to step S10. After the first assignment of the positive integer of “1000”, the information processor 2 stepwise increments the positive integer of 4 figures for the next music data files until “999999998”. The fourth figure makes the character string of the file name increased by one character.

The information processor 2 determines the new file name at step S10. The new file name includes the header 21 of “PIANO”, the integral part 22 of the positive integer given at step S4, S8 or S9 and an extension 23 arbitrarily added to the integral part. The positive integer expresses a character string. The information processor 2 converts the positive integer to the corresponding character string, and the character string, which is corresponding to the positive integer, occupies the integral part 22 of the file name.

When the information processor 2 finds the maximum score at “999999999”, the answer at step S3 is given “C1”, and the information processor 2 gives a warning to the user through the display panel 1j as by step S6. This is because of the fact that “999999999” is the maximum positive integer available for the integral part 22. The warning indicates that the user can not automatically give any file name to the new music data file through the software. The user may manually input a character string through the array of keys and switches 1k for the file name of the new music data file. Otherwise. the user may eliminate a disused music data file or files from the memory unit 3 so as to change the answer at step S5 from negative to affirmative. Upon completion of the jobs at step S6 or S10 the information processor 2 returns to the main routine program.

As will be understood from the foregoing description, the file name is automatically created for the new music data file through the subroutine program SB1. If only one file name already registered is expressed as “PIANO001”, “PIANO002” is assigned to the new music data file, and the positive integer is stepwise increased from 002 for new music data files created in future. If the minimum positive integer of 3 figures is “500”, the file name “PIANO 500” is assigned to the new music data file, and positive integers less than “998” is successively assigned to new music data files in future. If the maximum positive integer already assigned to the music data files is “999” without any skipped integer, the positive integer of “1000” is assigned to the new music data file, and the positive integer is stepwise increased toward “9999999 99” in future.

The information processing system 1h and subroutine program SB1 for assigning file names are advantageous in that the users easily determine the order of recording on the basis of the integral part 22 before the positive integer reaches “999” and in that the file names are economically assigned to the music data files after the positive integer reaches “999”.

Another advantage is to make the automatic player piano of present invention compatible to the automatic player pianos already sold in the market. In detail, small-sized display panel are incorporated in several models of the automatic player pianos, which are labeled with the trademark “YAMAHA”, and are capable of producing eleven characters at the maximum. While the positive integer is being incremented in the three figures, the file names are expressed as “PIANO xyz” where xyz are the positive integers of 3 figures, and eight characters form the base names 20 of the file names. Therefore, the music data files created by the information processing system 1h are readable in the automatic player pianos already used.

It is said that human being can bear 7±2 characters in mind for a relatively short time period. Since the information processor 2 assigns the skipped integers to new music data files, most of the music data files have the positive integers of 3 figures, and the file names automatically assigned to the music data files make the users easily keep the relation between the file names and the contents of the music data files. This is yet another advantage of the file names of the present invention.

### Second Embodiment

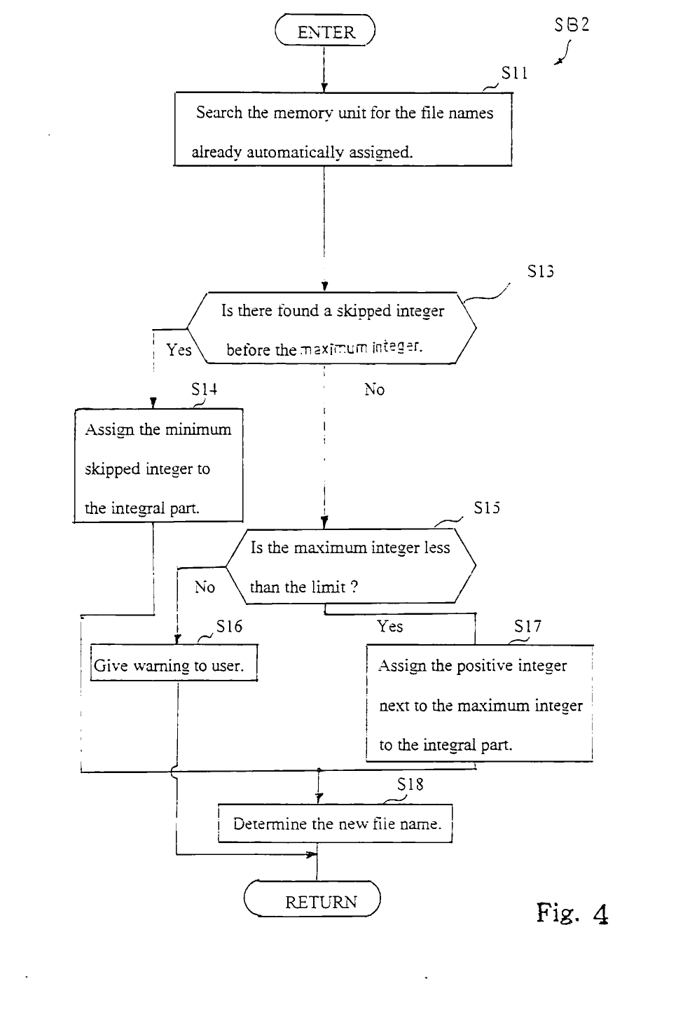

FIG. 4 shows another job sequence of a subroutine program SB2 for assigning a file name to a new music data file according to the present invention. The subroutine program SB2 runs on the information processor 2, which is incorporated in an information processing system, which in turn is incorporated in an automatic player piano. The information processing system and automatic player piano are similar in structure to those of the first embodiment, and, for this reason, description is focused on the subroutine program SB2 for avoiding undesirable repetition. The system components are labeled with references designating corresponding system components of the first embodiment so as to make the description clearly understandable.

Assuming now that a human player instructs the information processor 2 to store a set of music data codes representative of a performance on the acoustic piano 10 in the memory unit 3, the information processor 2 enters the subroutine program SB2.

The information processor 2 firstly searches the memory unit 3 for the file names already automatically assigned through the execution of the subroutine program SB2 as by step S11.

Subsequently, the information processor 2 checks the integral part 22 to see whether or not a skipped integer is found before the maximum integer of the file name already assigned as by step S13.

If a music data file has been eliminated from the memory unit 3 the positive integer in the file name is found to be a skipped integer, and the answer at step S13 is given affirmative “Yes”. When the information processor 2 finds plural skipped integers, the information processor 2 assigns the minimum skipped integer to the integral part 22 as by step S14.

If any music data file has not been eliminated from the memory unit 3, the answer at step S13 is given negative “No”, and the information processor 2 compares the maximum integer with the limit of positive integer “999999999” to see whether or not the maximum integer is less than the limit as by step S15. When the maximum integer is equal to the limit, the answer is given negative “No”, and the information processor 2 can not assign a file name to the new music data file. With the negative answer “No”, the information processor 2 requests the graphic controller 4 to produce a warning message on the display panel 1j as by step S16.

On the other hand, when the maximum integer is less than the limit “999999999”, the information processor 2 assigns the positive integer next to the maximum integer to the integral part as by step S17.

Upon completion of the jobs at step S14 or S17, the information processor 2 proceeds to step S18, and determines the file name, which includes the given integer in the integral part 22, for the new music data file.

As will be understood from the foregoing description, the files names are automatically assigned to the music data files through the execution of the subroutine program and the skipped integers are assigned to the new music data files. Thus, the file names are economically assigned to the music data files.

### Third Embodiment

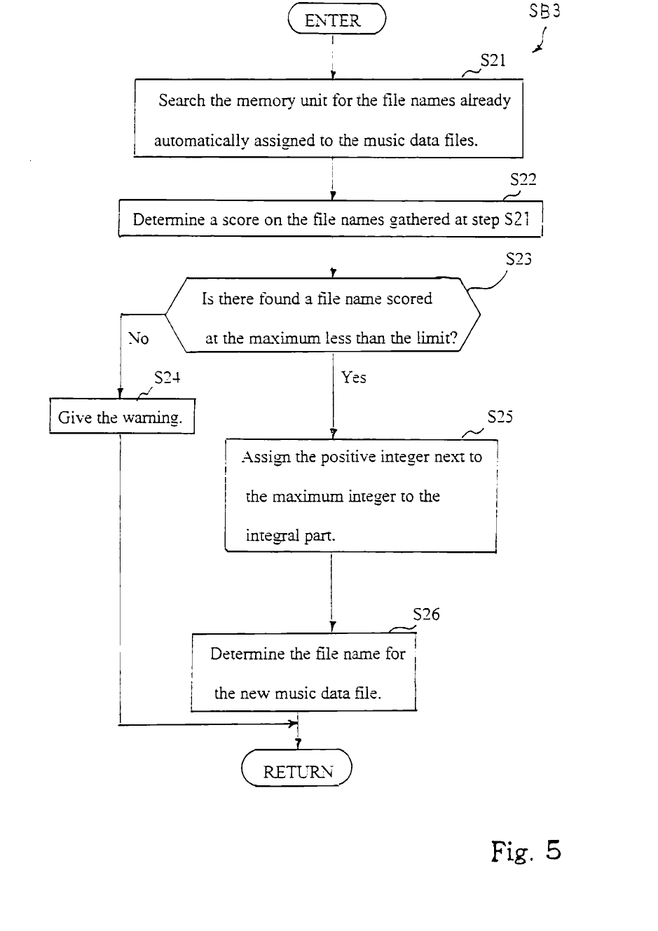

FIG. 5 shows yet another job sequence of a subroutine program SB3 for assigning a file name to a music data file. The subroutine program SB3 forms a part of a computer program together with the main routine program and other subroutine programs, and the computer program is installed in an automatic player piano, which is similar in structure to that of the first embodiment. For this reason, description is focused on the subroutine program SB3. System components of the automatic player piano are labeled with references designating the corresponding system components of the first embodiment without detailed description for the sake of simplicity.

A human player is assumed to instruct the information processor 2 to store a set of music data codes representative of a performance on the acoustic piano 10 in the memory unit 3. Then, the information processor 2 enters the subroutine program SB3.

The information processor 2 searches the memory unit 3 for the file names already automatically assigned to the music data files as by step S21. When a file name is found at step S21, the information processor 2 adds the file name to a file name list.

Subsequently, the information processor 2 scores certain points to the file names in the file name list as by step S22. The information processor 2 determines the maximum score. If any file name is not found at step S21, the information processor 2 determines that the maximum score is zero. The information processor 2 compares the score with the limit of the positive integer, i.e., “999999999” to see whether or not the maximum score is less than the limit as by step S23.

If the positive integer has been already assigned to the integral part 22 of the file name in the file name list, the answer at step S23 is given negative “No”. With the negative answer, the information processor 2 requests the graphic controller 4 to produce a warning message on the display panel 1j as by step S24.

On the other hand, when the maximum integer is less than the limit, the answer is given affirmative “Yes”. In other words, there is at least one positive integer, which has not been assigned to any music data file, yet. With the positive answer, the information processor 2 assigns the positive integer next to the maximum integer to the integral part 22 as by step S25.

Subsequently, the information processor 2 determines the file name as {(PIANO+Positive Integer)+an extension}, and assigns the file name to the new music data file as by step S26.

As will be understood from the foregoing description, the files names are automatically assigned to the music data files through the execution of the subroutine program, and the integral parts are indicative of the order of creating the music data files. Thus, the users easily find the newest music data file on the basis of the integral parts of the file names.

Although particular embodiments of the present invention have been shown and described, it will be apparent to those skilled in the art that various changes and modifications may be made without departing from the spirit and scope of the present invention.

The subroutine program for a file name may be offered to users in the form of an application program. In case where a controller is designed for music data codes supplied from the outside of the musical instrument, the computer program may not include the subroutine program for the recorder 1e.

The present invention may appertain to an automatic player system, which makes an acoustic piano retrofitted to an automatic player piano.

The positive integers of 3 figures do not set any limit to the technical scope of the present invention. Positive integers of more than 3 figures may be assigned to the integral part, or users may give the maximum positive integer to the integral part.

Similarly, the length of character string may be longer than or shorter than the character string shown in FIG. 2. The length of character string expressing the file name may be dependent of the maximum number of character images concurrently produced on the display panel 1j.

The character string “PIANO” does not set any limit to the technical scope of the present invention. Another character string, which is shorter than or longer than the character string PIANO, may be used as the header. The header 21 may be expressed by using small letters.

The warning may be given in the form of voice message.

When the information processor 2 assigns the positive integers of 4 figures at step S9, the information processor may decrease the characters of the header by one. The file name is expressed as “PIAN 1000”. When the positive integers of 5 figures are assigned to file names, the number of characters in the header 21 may be decreased by two. As a result, the total length of character strings expressing the base name 20 is kept constant.

The decimal numeral and alphabet letters do not set any limit to the technical scope of the present invention. The hexadecimal notation system may be employed as the integral part 22, and Chinese letters and/or Japanese letters may be used in the base name 20.

The base name 20 may be expressed only by the integral part 22. In other words, the base names 20 do not have any header 21.

When the maximum positive integer exceeds “1000”, the information processor 2 may check the memory unit 3 to see whether or not a skipped integer is found.

The automatic player piano does not set any limit to the technical scope of the present invention. The present invention may appertain to a recording system for another sort of musical instruments such as, for example, a mute piano, an electric stringed musical instrument, an electric percussion instrument, an electronic keyboard and the likes. The present invention may appertain to an electronic device assisting music fans. A typical example of the electronic device is a sampler.

Claim languages are correlated with the component parts of the above-described embodiments as follows.

The information processing system la and the part of the subroutine program SBb serve as a “music data producer”, and the information processing system 1a and subroutine program SB1, SB2 or SB3 serve as a “file name assigner”. The positive integers from “001” to “999” form a “numerical range”, and the positive integers from “1000” to “999999999” form an “extended numerical ranges”.

As to the former two independent claims, the information processing system 1a and steps S1/S2/S3 or S11 serve as a “first searcher”, and the information processing system 1a and steps S5/S7 or S13 serve as a “second searcher”. The information processing system la and step S8/S10 or S14/S18 serve as a “namer”.

As to the latter two independent claims, the information processing system 1a and steps S1/S2/S3 or S21/S22/S23 serve as a “first searcher”, and the information processing system 1 a and step S4 or S25 serve as a “namer”.

The black and white keys 11a and 11b are corresponding to “plural manipulators”, and the action units 12, hammers 13 and strings 14 as a whole constitute a “tone generating system”.

The information processing system 1a and step S6, S16 or S24 serve as a “messenger”.

What is claimed is:

1. A controller for automatically assigning a file name to a music data file. comprising:
a music data file producer creating a music data file in a memory for storing a set of music data codes; and
a file name assigner assigning a file name to said music data file, and including
a first searcher searching said memory for a maximum number forming a part of another file name assigned to another music data file already stored in said memory.
a second searcher searching said memory for a skipped number less than said maximum number and
a namer introducing said skipped number into said file name when said second searcher finds said skipped number and assigning said file name to said music data file.

2. The controller as set forth in claim 1, in which said namer introduces a minimum skipped number into said file name when said second searcher finds plural skipped numbers.

3. The controller as set forth in claim 1, in which said namer introduces a number next to said maximum number instead of said skipped number to said file name when said first searcher finds said maximum number less than a limit of a numerical range.

4. The controller as set forth in claim 3, in which said namer introduces said skipped number to said file name when said maximum number is equal to said limit of said numerical range.

5. The controller as set forth in claim 4, in which said namer gives a number selected from an extended numerical range greater than said limit of said numerical range to said file name on the conditions that said first searcher finds said maximum number to be equal to said limit of said numerical range and that said second searcher does not find said skipped number in said numerical range.

6. The controller as set forth in claim 5, in which said file name assigner further includes a messenger giving a warning to users when said maximum number reaches the limit of said extended numerical range without fining said skipped number.

7. A musical instrument for performing a piece of music, comprising:
plural manipulators selectively manipulated by a human player for specifying pitch names along said piece of music;
a tone generating system connected to said plural manipulators, and producing tones having said pitch names:
a music data producer connected to said plural manipulators, and producing a set of music data codes expressing a performance along said piece of music;
a music data file producer creating a music data file in a memory for storing said set of music data codes; and
a file name assigner assigning a file name to said music data file, and including
a first searcher searching said memory for a maximum number forming a part of another file name assigned to another music data file already stored in said memory.
a second searcher searching said memory for a skipped number less than said maximum number and
a namer introducing said skipped number into said file name when said second searcher finds said skipped number and assigning said file name to said music data file.

8. The musical instrument as set forth in claim 7, in which said namer introduces a minimum skipped number into said file name when said second searcher finds plural skipped numbers.

9. The musical instrument as set forth in claim 7, in which said namer introduces a number next to said maximum number instead of said skipped number to said file name when said first searcher finds said maximum number less than a limit of a numerical range.

10. The musical instrument as set forth in claim 9, in which said namer introduces said skipped number into said file name when said first searcher finds said maximum number equal to said limit of said numerical range.

11. The musical instrument as set forth in claim 10, in which said namer gives a number selected from an extended numerical range greater than said limit of said numerical range to said file name on the conditions that said first searcher finds said maximum number equal to said limit of said numerical range and that said second searcher does not find said skipped number in said numerical range.

12. The musical instrument as set forth in claim 11, in which said file name assigner further includes a messenger giving a warning to users when said maximum number reaches the limit of said extended numerical range without fining said skipped number.

11. A controller for automatically assigning a file name to a music data file, comprising:
a music data file producer creating a music data file in a memory for storing a set of music data codes: and
a file name assigner assigning a file name to said music data file, and including
a first searcher searching said memory for another music data file having a maximum number less than a limit of numerical range and
a namer introducing the number next to said maximum number into said file name and assigning said file name to said music data file.

12. The controller as set forth in claim 11, in which said file name assigner further includes a second searcher searching said memory for a skipped number in said numerical range, and said namer introduces said skipped number into said file name when said first searcher finds said maximum number equal to said limit of said numerical range.

13. The controller as set forth in claim 12, in which said namer introduces a minimum skipped number into said file name when said second searcher finds plural skipped numbers.

14. The controller as set forth in claim 12, in which said namer introduces a number selected from an extended numerical range greater than said limit of said numerical range into said file name when said first searcher finds said maximum number equal to said limit and when said second searcher does not find said skipped number.

15. The controller as set forth in claim 14, in which said file name assigner further includes a messenger giving a warning to users on the condition that said first searcher finds said i maximum number equal to a limit of said extended numerical range and when said second searcher does not find said skipped number.

16. A musical instrument for performing a piece of music, comprising:
plural manipulators selectively manipulated by a human player for specifying pitch names along said piece of music;
a tone generating system connected to said plural manipulators, and producing tones having said pitch names;
a music data producer connected to said plural manipulators, and producing a set of music data codes expressing a performance along said piece of music;
a music data file producer creating a music data file in a memory for storing said set of music data codes; and
a file name assigner assigning a file name to said music data file, and including
a first searcher searching said memory for another music data file having a maximum number less than a limit of numerical range and
a namer introducing the number next to said maximum number into said file name and assigning said file name to said music data file.

17. The musical instrument as set forth in claim 16, in which said file name assigner further includes a second searcher searching said memory for a skipped number in said numerical range, and said namer introduces said skipped number into said file name when said first searcher finds said maximum number equal to said limit of said numerical range.

18. The musical instrument as set forth in claim 17, in which said namer introduces a minimum skipped number into said file name when said second searcher finds plural skipped numbers.

19. The musical instrument as set forth in claim 17, in which said namer introduces a number selected from an extended numerical range greater than said limit of said numerical range into said file name when said first searcher finds said maximum number equal to said limit and when said second searcher does not find said skipped number.

20. The musical instrument as set forth in claim 19, in which said file name assigner further includes a messenger giving a warning to users on the condition that said first searcher finds said maximum number equal to a limit of said extended numerical range and when said second searcher does not find said skipped number.
